(19) United States
(12) Patent Application Publication
(10) Pub. No.: US 2026/0132836 A1
(43) Pub. Date: May 14, 2026

(54) ADJUSTMENT DEVICE FOR A DAMPER VALVE, DAMPER VALVE, AND A VIBRATION DAMPER

(71) Applicants: thyssenkrupp Bilstein GmbH, Ennepetal (DE); thyssenkrupp AG, Essen (DE)

(72) Inventors: Jens ROBRECHT, Nettersheim (DE); Martin FLICK, Gummersbach (DE)

(73) Assignees: thyssenkrupp Bilstein GmbH, Ennepetal (DE); thyssenkrupp AG, Essen (DE)

(21) Appl. No.: 19/384,930

(22) Filed: Nov. 10, 2025

(30) Foreign Application Priority Data
Nov. 11, 2024 (DE) 10 2024 132 756.1

(51) Int. Cl. F16F 9/46; B60G 17/08

(52) U.S. Cl. CPC F16F 9/467; B60G 17/08; B60G 2202/24; B60G 2206/41; B60G 2600/20; F16F 2230/186

(57) ABSTRACT

An adjustment device for a damper valve comprises at least one adjustment shaft and at least one adjustment element, which have a common axis of rotation, wherein the adjustment element is connected in a rotationally conjoint manner to the adjustment shaft, and wherein, for setting of a damping force, at least one control disc is connected or connectable to the adjustment shaft, wherein the adjustment element is rotatable about the axis of rotation without a stop in such a way that a rotational movement of the adjustment element is realized free of a delimitation in any direction of rotation.

### CROSS REFERENCE TO RELATED APPLICATION

This application is a U.S. Non-Provisional that claims priority to German Patent Application No. DE 10 2024 132 756.1, filed Nov. 11, 2024, the entire content of which is incorporated herein by reference.

### FIELD

The present disclosure relates to an adjustment device for a damper valve, to a damper valve, and to a vibration damper.

### BACKGROUND

A large number of vibration dampers are used in the automotive sector. It is known that an adaptable damping capable of being switched between a soft setting, for increased driving comfort, and a hard setting, for increased driving safety, according to situation is advantageous. In this case, vibration dampers whose damping force is variable normally have switchable valve devices in order to set the damping. This makes it possible for soft damping and hard damping to be set.

Adjustment devices for setting damping force in which use is made of spring-disc packs that are preloaded by a spring are known from the prior art. The preload force of the spring allows different opening pressures to be set, for example by hand. It is known that increased preloading of the spring-disc packs makes it more difficult for a damping force to be adjusted by hand. In addition, such an adjustment device has an increased structural size and an increased weight.

Thus a need exists for specifying an adjustment device for a damper valve that allows manual adjustment of the damping force by simple handling, on the one hand, and without damage to the valve unit, on the other hand. The disclosure is furthermore based on the problem of specifying a damper valve having an adjustment device of said type and a vibration damper having such a damper valve.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a perspective illustration of a vibration damper according to an exemplary embodiment according to the invention.

FIG. 2 shows a perspective illustration of an adjustment device according to the invention according to an exemplary embodiment according to the invention.

FIG. 3 shows a perspective illustration of an adjustment device according to the invention as per FIG. 2.

FIG. 4 shows a longitudinal section through an adjustment device according to the invention as per FIG. 2.

FIG. 5 shows a perspective illustration of an adjustment device according to the invention as per FIG. 2.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Some embodiments include an adjustment device for a damper valve that has at least one adjustment shaft and at least one adjustment element, which have a common axis of rotation, wherein the adjustment element is connected in a rotationally conjoint manner to the adjustment shaft, and wherein, for setting of a damping force, at least one control disc is connected or connectable to the adjustment shaft. The adjustment element is rotatable about the axis of rotation without a stop in such a way that a rotational movement of the adjustment element is realized free of a delimitation in any direction of rotation.

An advantage of the invention is that, by rotating the adjustment element, manual adjustment of the damping force is easy to realize, without an end stop being reached in the process. This advantageously results in it being possible for an operator to actuate the adjustment element, preferably by hand, since it is not the case, as is known from the prior art, that the actuation is realized counter to the preload force of a spring, but rather the adjustment element is rotated. The adjustment device according to the invention thus allows the damping force to be set by simple handling in order to realize, according to requirements, relatively soft or relatively hard damping of a vibration damper.

For adjustment of the damping force of the adjustment device according to the invention, the adjustment element and the adjustment shaft have a common axis of rotation, wherein the adjustment element is connected in a rotationally conjoint manner to the adjustment shaft. The adjustment element is preferably designed in such a way that additional mechanical delimitations, such as for example end stops or stoppers, are dispensed with. This has the advantage that the adjustment element can be rotated about the axis of rotation in a direction of rotation as often as desired. Rotation of the adjustment element without a stop results in special security when adjusting the damping force, since incorrect operation due to impermissibly forceful rotation of the adjustment element against a stop is eliminated. An advantageous result of this is that the adjustment element can be rotated by a user in both directions of rotation without damage. Damage-free setting makes it possible to set the damping force without damaging valve components as a result of incorrect settings. This reduces wear and increases the service life of the valve unit. In addition, the adjustment device according to the invention is able to be produced with a reduced structural size and a reduced weight.

A further advantage of the invention is that the rotation of the adjustment element without a stop renders the use of a tool unnecessary. The adjustment element is preferably accessible from the outside and rotatable by hand, so that no overloading and thus damage to the adjustment mechanism, for example due to incorrect operation of the tool, can occur. Rotation is advantageously possible in a substantially force-free manner, that is to say with little application of force.

For setting of the damping force of the adjustment device according to the invention, the control disc is connected or connectable to the adjustment shaft. The control disc preferably has at least two passage openings of different cross section in order to alter a flow of the damper fluid, in particular a flow cross section, through the passage channels of a valve body of the damper valve. The passage openings of the control disc and the passage channels of the valve body can correspond or be spaced apart from one another according to the rotational position of the control disc. In other words, one or more of the passage openings of the control disc can be brought into overlap with the passage channels of the valve body in various rotational positions.

Preferably, the control disc is able to be rotated by the adjustment element in stages, in particular in a stepwise manner. In other words, the control disc is advantageously actuatable via the adjustment element. In this case, the control disc is able to be rotated in even steps with the aid of the adjustment element. Put differently, the rotation of the control disc from one position into the next is advantageously realized uniformly. This makes possible simple and precise, in particular reproducible, setting of the damping force of the vibration damper.

Preferably, the damper valve with the adjustment device according to the invention is used on a vibration damper of a motor vehicle. Particularly preferably, the damper valve with the adjustment device is used on vibration dampers for racing since the adjustment device makes possible manual adaptation of the damping force and thus exact adaptation of the damping to the track conditions or the driving style, etc. The invention is not limited to the use on vibration dampers for racing. Other fields of use are possible.

Preferably, the adjustment element is freely rotatable in both directions of rotation without rotational-position delimitation. As a result, at least two successive rotations of 360° are possible without a change in direction in order to adjust the damping force. Consequently, it is advantageously achieved that a direct change from a maximum soft damping to a maximum hard damping or from a maximum hard damping to a maximum soft damping is possible. In other words, it is possible to jump from a maximum hard setting to a maximum soft setting and vice versa. The damping is preferably able to be varied by rotation of the adjustment element in both directions of rotation.

In a preferred embodiment, the adjustment element is rotatable in both directions of rotation in any rotational position. Consequently, it is advantageously achieved that the adjustment element can be rotated both clockwise and anticlockwise irrespective of the rotational position of the adjustment element in relation to the axis of rotation.

Preferably, the adjustment element is rotatable without a stop from at least one release position into at least one arresting position. For this purpose, the adjustment device according to the invention is preferably configured in such a way that the adjustment element is able to be brought from the release position into the arresting position without a stop. This has the advantage that a desired damping is able to be set easily.

In a preferred embodiment, the adjustment device has at least one latching disc which is connected in a rotationally conjoint manner to the adjustment shaft, wherein the adjustment device, in the release position, is able to be brought into different rotational positions without a stop by way of the latching disc in order to adjust the damping force. This is preferably to be understood in such a way that, when the adjustment shaft is actuated, the latching disc advantageously follows the rotation of the adjustment shaft. Furthermore, the rotation of the latching disc can advantageously be realized without any tools. Consequently, the latching disc can assume different rotational positions so as to adjust the damping force. Preferably, the latching disc is able to be rotated in stages by the adjustment element and comprises in the direction of rotation at least ten rotational positions for opening up and/or blocking the passage channels of the damper valve. Here, it is advantageous that the damper valve is usable for different fields of use by way of a variable number of rotational positions.

The latching disc is preferably designed so as to assume any intermediate position between maximum soft and maximum hard. A multiplicity of different rotational positions makes possible improved settability of the damping.

Preferably, the adjustment device has at least one locking body, wherein the latching disc is able to be fixed in the arresting position by the locking body. The locking body is preferably movable between a release position and an arresting position so as to block or release the latching disc. If the locking body of the adjustment device is blocked, the latching disc is fixed in the arresting position. In this way, it is possible for the latching disc to be fixed without damage in the arresting position by the locking body in the desired rotational position, so that the damping force is set. In the arresting position, the locking body is preferably arranged in such a way that rotation of the latching disc is avoided. The locking body makes it possible for the latching disc to be fixed precisely and/or released.

Preferably, in the arresting position, the locking body is connected in a form-fitting manner to the latching disc. This is to be understood in such a way that the locking body forms a form fit with the latching disc in the arresting position. Consequently, in the arresting position, the latching disc is connected in a substantially rotationally fixed manner to the valve body of the damper valve.

In a further preferred embodiment, the locking body is able to be preloaded in the direction of the latching disc by at least one restoring mechanism in order for the latching disc to be fixed in the arresting position. In this way, it can be easily achieved that the locking body is preloaded against the latching disc so as to ensure a reliable flow through the valve body. In the case of the release of the latching disc, the restoring mechanism makes it possible for the locking body to be easily returned from the arresting position into the release position. This has the advantage of simple operation.

Furthermore, the latching disc has multiple openings for receiving the locking body in at least one of the rotational positions, wherein the openings are spaced apart from one another and are arranged so as to be distributed in the circumferential direction of the latching disc. This advantageously makes it possible for the damping force to be adapted in steps. This is preferably to be understood in such a way that a clockwise or anticlockwise rotation of the latching disc leads to certain passage openings of the control disc being opened up or blocked. Consequently, relatively soft or relatively hard damping can be set in a simple and precise manner.

Preferably, by way of the restoring mechanism, in the arresting position, the locking body engages, in particular in a form-fitting manner, into one of the openings in the latching disc. This has the advantage of mechanical securing. The locking body is seated firmly and securely in one of the openings, whereby for example undesired release of the latching disc and adjustment of the damping force are prevented.

Furthermore, the adjustment device is arranged in a valve housing of the damper valve and is in particular accessible from the outside. This arrangement of the adjustment device allows the damping to be set in a simple and precise manner by hand. The access from the outside makes convenient operation possible. The damping force can be adjusted without any tools. This has the advantage that the adjustment can be carried out without overloading and thus damage to the adjustment mechanism, for example due to incorrect operation of a tool. This increases the service life of the adjustment mechanism. In addition, the adjustment device is protected against external influences.

In a further preferred embodiment, the valve housing has at least one receiving region in which the restoring mechanism extends and into which the locking body is inserted at least sectionally in the release position and in the arresting position. The arrangement of the restoring mechanism and the locking body in the receiving region makes it possible to realize a compact structural size of the adjustment device. This arrangement can facilitate maintenance because the locking body and the restoring mechanism are arranged in the same receiving region and are easily accessible, which saves time and costs during servicing.

Preferably, the locking body is of substantially spherical form. In other words, the locking body has substantially the shape of a sphere. Other configurations of the locking body are possible. As a result of the spherical shape of the locking body, it is achieved that the locking body, in the release position, can easily slide out of the receiving region, and easily slide into one of the openings again, during the rotation of the latching disc. This ensures an adjustment of the damping force that is reduced in force as much as possible.

According to an additional independent aspect, the invention relates to a damper valve for a vibration damper that has at least one adjustment device according to the invention.

In this respect, reference is made to the advantages explained in connection with the adjustment device. Furthermore, the damper valve may alternatively or additionally have individual features or a combination of multiple features from among those mentioned above in relation to the adjustment device.

Some embodiments include a vibration damper for a motor vehicle that has at least one damper valve of said type.

With regard to the advantages of the vibration damper, reference is made to the advantages explained in connection with the adjustment device. Furthermore, the vibration damper may alternatively or additionally have individual features or a combination of multiple features from among those mentioned above in relation to the adjustment device.

The invention will be discussed in more detail below with reference to the appended drawings. The embodiments illustrated provide examples of how the adjustment device according to the invention can be designed.

Below, the same reference numerals are used for identical or identically acting parts.

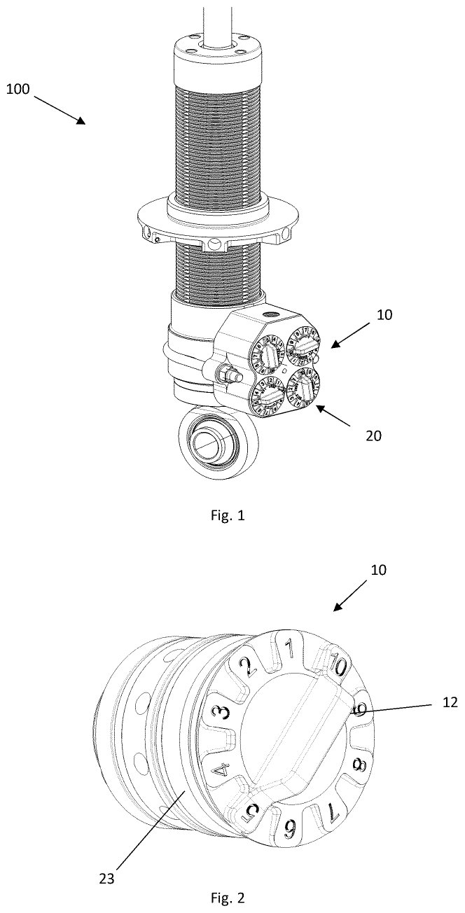

FIG. 1 shows for example a vibration damper 100 with a damper valve 20 in which the adjustment device 10 is used. Here, the use of the damper valve 20 with the adjustment device 10 in a vibration damper 100 for a motorized vehicle is involved. Specifically, the damper valve 20 with the adjustment device 10 is used in a vibration damper 100 for motorsports vehicles, in particular for racing cars or sports cars. Other uses are possible.

The vibration damper 100 according to FIG. 1 has four damper valves 20, wherein the damper valves 20 serve for rebound-stage and compression-stage damping. Two of the damper valves 20 shown in FIG. 1 serve for rebound-stage and compression-stage damping in the high-speed range. By contrast, the two further damper valves 20 serve for rebound-stage and compression-stage damping in the low-speed range. The vibration damper 100 is preferably used in motor vehicles. The vibration damper 100 is particularly preferably used for motorsports vehicles, in particular for racing cars or sports cars. Other fields of use are possible.

FIG. 2 shows a perspective illustration of the adjustment device 10 according to the invention. As shown in FIG. 2, the adjustment element 12 is rotatable about the axis of rotation L without a stop in such a way that a rotational movement of the adjustment element 12 is realized free of a delimitation in the direction of rotation.

It can be furthermore seen from FIG. 2 that the adjustment element 12 is freely rotatable in both directions of rotation without rotational-position delimitation.

FIG. 2 furthermore shows that the adjustment element 12 is rotatable in both directions of rotation in any rotational position. The adjustment element 12 can be rotated both clockwise and anticlockwise irrespective of the rotational position of the adjustment element 12 in relation to the axis of rotation.

It can furthermore be seen from FIG. 2 that the adjustment element 12 is rotatable without a stop from at least one release position into at least one arresting position.

The adjustment device 10 according to FIG. 2 has multiple rotational positions. Specifically, the adjustment device 10 is able to be brought into ten rotational positions. The rotational positions are indicated by numbers from one to ten. The numbers serve for the setting of different damping levels. In the case of relatively small numbers, the flow rate is increased, resulting in relatively soft damping. In the case of relatively large numbers, the flow of the damper fluid is reduced, resulting in relatively hard damping. If the adjustment element 12 according to FIG. 2 is rotated clockwise in the direction of rotation from one to ten, the damping force is increased. Rotating the adjustment element 12 from ten to one reduces the damping force, resulting in relatively soft damping. Furthermore, due to the adjustment of the adjustment element 12 without a stop, direct switching from one to ten and vice versa is possible.

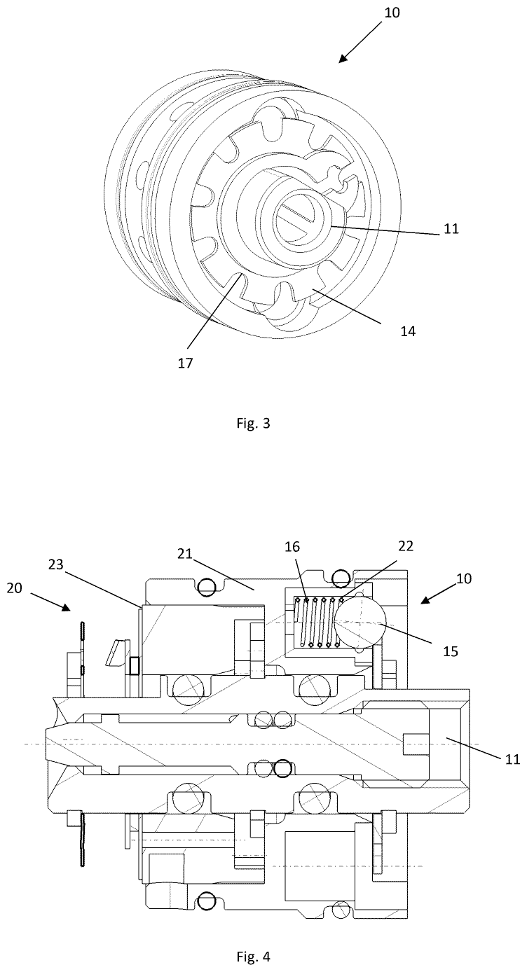

FIG. 3 shows an exemplary embodiment according to the invention of an adjustment device 10 for a damper valve 20.

As shown in FIG. 3, the adjustment device 10 has a latching disc 14. Furthermore, FIG. 3 clearly shows that the latching disc 14 is connected in a rotationally conjoint manner to the adjustment shaft 11. Specifically, when the adjustment shaft 11 is actuated, the latching disc 14 follows the rotation of the adjustment shaft 11. The adjustment device 10, in the release position, is able to be brought into different rotational positions without a stop by way of the latching disc 14 in order to adjust the damping force. The latching disc 14 is in this case of disc-shaped form.

As shown in FIG. 3, the latching disc 14 has multiple openings 17 for receiving the locking body 15 in at least one of the rotational positions. The openings 17 are spaced apart from one another and are arranged in the circumferential direction of the latching disc 14. The openings 17 make it possible for the damping force to be adapted in steps. According to FIG. 3, the openings 17 are of U-shaped form. Other forms are conceivable. The openings 17 are arranged so as to be distributed uniformly in a circumferential direction of the latching disc 14. A non-uniform distribution of the openings 17 is possible.

FIG. 4 shows a longitudinal section through an adjustment device 10 according to the invention. The adjustment device 10 has a locking body 15. The latching disc 14 is able to be fixed in the arresting position by the locking body 15. The locking body 15 is movable between a release position and an arresting position so as to block or release the latching disc 14. If the locking body 15 of the adjustment device 10 is blocked, the latching disc 14 is fixed in the arresting position. The latching disc 14, in the desired rotational position, is able to be fixed without damage in the arresting position by the locking body 15. The locking body 15 makes it possible for the latching disc 14 to be fixed precisely and/or released. In the arresting position, the locking body 15 is connected in a form-fitting manner to the latching disc 14.

It can furthermore be seen in FIG. 4 that the locking body 15 is preloaded in the direction of the latching disc 14 by a restoring mechanism 16 in order for the latching disc 14 to be fixed in the arresting position. During the release of the latching disc 14, the locking body 15 is returned into the release position from the arresting position by way of the restoring mechanism 16. The restoring mechanism 16 is in the form of a restoring spring in FIG. 4. Other forms are possible.

By way of the restoring mechanism 16, in the arresting position, the locking body 15 engages, in particular in a form-fitting manner, into one of the openings 17 in the latching disc 14.

FIG. 4 furthermore shows that the adjustment device 10 is arranged in a valve housing 21 of the damper valve 20. As shown in FIG. 4, the adjustment device 10 is accessible from the outside.

The valve housing 21 according to FIG. 4 has a receiving region 22. The restoring mechanism 16 extends in the receiving region 22. The locking body 15 is inserted at least sectionally into the receiving region 22 in the release position and in the arresting position.

It can furthermore be seen from FIG. 4 that the locking body 15 is of substantially spherical form. Other forms of the locking body 15 are possible.

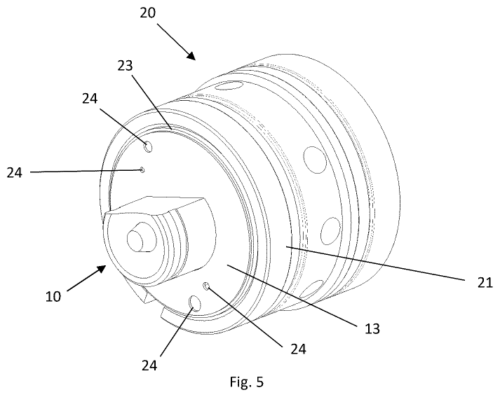

The damper valve 20 has a valve body 23 which is integrated into the valve housing 21. The valve body 23 is able to be flowed through by a damper fluid. From FIG. 5, it can be clearly seen that a control disc 13 is arranged on the valve body 23 of the damper valve 20. The control disc 13 is oriented coaxially with respect to the valve body 23. Specifically, the control disc 13 lies directly against the valve body 23 and, in so doing, is configured in such as a way as to allow or block a flow of damper fluid through the valve body 23.

As FIG. 5 shows, the control disc 13 is connected in a rotationally conjoint manner to the adjustment shaft 11.

Furthermore, the control disc 13 shown in FIG. 5 is relatively rotatable with respect to the valve body 23. In this case, the valve body 23 is arranged in a fixed manner. The control disc 13 is rotatable relative to the valve body 23.

It can be clearly seen from FIG. 5 that the control disc 13 has four passage openings 24 of different cross section. FIG. 5 shows that the control disc 13 is able to be brought into different rotational positions, wherein one or more of the passage openings 24 for the flow of the damper fluid are opened up or blocked according to the rotational position of the control disc 13.

### LIST OF REFERENCE SIGNS

10 Adjustment device
11 Adjustment shaft
12 Adjustment element
13 Control disc
14 Latching disc
15 Locking body
16 Restoring mechanism
17 Openings
24 Passage openings
20 Damper valve
21 Valve housing
22 Receiving region
23 Valve body
100 Vibration damper

1. An adjustment device for a damper valve, comprising:
at least one adjustment shaft and at least one adjustment element, which have a common axis of rotation;
wherein the adjustment element is connected in a rotationally conjoint manner to the adjustment shaft;
wherein, for setting of a damping force, at least one control disc is connected or connectable to the adjustment shaft;
wherein the adjustment element is rotatable about the axis of rotation without a stop in such a way that a rotational movement of the adjustment element is realized free of a delimitation in any direction of rotation.

2. The adjustment device according to claim 1, wherein the adjustment element is freely rotatable in both directions of rotation without rotational-position delimitation.

3. The adjustment device according to claim 1, wherein the adjustment element is rotatable in both directions of rotation in any rotational position.

4. The adjustment device according to claim 1, wherein the adjustment element is rotatable without a stop from at least one release position into at least one arresting position.

5. The adjustment device according to claim 4, wherein the adjustment device has at least one latching disc which is connected in a rotationally conjoint manner to the adjustment shaft, wherein the adjustment device, in the release position, is able to be brought into different rotational positions without a stop by way of the latching disc in order to adjust the damping force.

6. The adjustment device according to claim 5, wherein the adjustment device has at least one locking body, wherein the latching disc is able to be fixed in the arresting position by the locking body.

7. The adjustment device according to claim 6, wherein in the arresting position, the locking body is connected in a form-fitting manner to the latching disc.

8. The adjustment device according to claim 6, wherein the locking body is able to be preloaded in the direction of the latching disc by at least one restoring mechanism in order for the latching disc to be fixed in the arresting position.

9. The adjustment device according to claim 6, wherein the latching disc has multiple openings for receiving the locking body in at least one of the rotational positions, wherein the openings are spaced apart from one another and are arranged so as to be distributed in the circumferential direction of the latching disc.

10. The adjustment device according to claim 9, wherein by way of the restoring mechanism, in the arresting position, the locking body engages into one of the openings in the latching disc.

11. The adjustment device according to claim 9, wherein by way of the restoring mechanism, in the arresting position, the locking body engages in a form-fitting manner into one of the openings in the latching disc.

12. The adjustment device according to claim 1, wherein the adjustment device is arranged in a valve housing of the damper valve.

13. The adjustment device according to claim 1, wherein the adjustment device is arranged in a valve housing of the damper valve and is accessible from the outside.

14. The adjustment device according to claim 1, wherein the valve housing has at least one receiving region in which the restoring mechanism extends and into which the locking body is inserted at least sectionally in the release position and in the arresting position.

15. The adjustment device according to claim 1, wherein the locking body is of substantially spherical form.

16. A damper valve for a vibration damper, having at least one adjustment device according to claim 1.

17. A vibration damper for a motorized vehicle, having at least one damper valve according to claim 16.
